(19) United States
(12) Patent Application Publication
(10) Pub. No.: US 2021/0134510 A1
(43) Pub. Date: May 6, 2021

(54) ELECTRONIC DEVICE

(71) Applicant: ANALOG DEVICES INTERNATIONAL UNLIMITED COMPANY, Co. Limerick (IE)

(72) Inventors: Michael John Anderson, Campbell, CA (US); George Anthony Serpa, San Jose, CA (US); Jerold Lee, Union City, CA (US)

(21) Appl. No.: 17/085,465

(22) Filed: Oct. 30, 2020

Related U.S. Application Data
(60) Provisional application No. 62/928,755, filed on Oct. 31, 2019.

(51) Int. Cl. H01F 27/08; H01F 27/28; H01F 27/24

(52) U.S. Cl. CPC H01F 27/08; H01F 27/24; H01F 27/2804

(57) ABSTRACT

An electronic device is disclosed. The electronic device can include an electronic component. The electronic device can include a shaped body in which the electronic component is at least partially embedded, the shaped body comprising a base portion and a plurality of heat-dissipating projections extending outwardly therefrom. In some embodiments, the electronic device can include a passive electronic device, such as an inductor or transformer.

### CROSS-REFERENCE TO RELATED APPLICATIONS

This application claims priority to U.S. Provisional Patent Application No. 62/928,755, filed Oct. 31, 2019, the entire contents of which are incorporated by reference herein in their entirety and for all purposes.

### BACKGROUND

### Field of the Invention

The field relates to an electronic device and, in particular, to a shaped passive electronic device.

### Description of the Related Art

Electronic devices, such as high power regulators, may use large inductors to achieve low resistance and high current capabilities which result in efficient, high power switching products. Some such devices may be integrated into small form factor, high performance electronic modules that perform many different types of functions. However, in some arrangements, the inductor may be large relative to other components of the electronic module and may occupy an excessive amount of space in the device, which can increase the overall size of the device and/or reduce performance. Accordingly, there is a continuing need for improved electronic devices for integration into larger systems.

### SUMMARY

In one embodiment, an electronic device is disclosed. The electronic device can include an electronic component. The electronic device can include a shaped body in which the electronic component is at least partially embedded, the shaped body comprising a base portion and a plurality of heat-dissipating projections extending outwardly therefrom. In some embodiments, the electronic device can include a passive electronic device, such as an inductor or transformer.

In another embodiment, an electronic device is disclosed. The electronic device can include an integrated device package comprising one or more integrated device dies. The electronic device can include a surface-mounted electronic component mounted to an exterior surface of the integrated device package. The surface-mounted electronic component can comprise a shaped electronic device, the shaped electronic device having a plurality of integral heat-dissipating projections extending outwardly therefrom.

In another embodiment a method of manufacturing an electronic device is disclosed. The method can include at least partially embedding at least one electronic component within a shaped body. The shaped body can include a plurality of heat-dissipating projections extending outwardly therefrom.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

Embodiments of this disclosure will now be described, by way of non-limiting example, with reference to the accompanying drawings.

FIG. 1 is a schematic perspective view showing an example of an electronic assembly.

FIG. 2 is a schematic perspective view showing another example of an electronic assembly.

FIG. 3 is a schematic perspective view showing another example of an electronic assembly.

FIG. 4A shows an electronic component including a conductive element comprising an inductor coil mounted to a frame.

FIG. 4B shows a molded body formed around the inductor coil of FIG. 4A.

FIG. 4C shows an electronic device comprising the molded body of FIG. 4B after separation from the frame.

FIG. 5A shows an electronic device comprising a molded body.

FIG. 5B shows an electronic device comprising a molded body having a plurality of fin-shaped projections.

FIG. 5C shows an electronic device comprising a molded body having a plurality of pin-shaped projections.

FIG. 6A shows a schematic side view of an electronic component according to another embodiment.

FIG. 6B shows a schematic side sectional view of a molded body formed around the electronic component of FIG. 6A.

### DETAILED DESCRIPTION

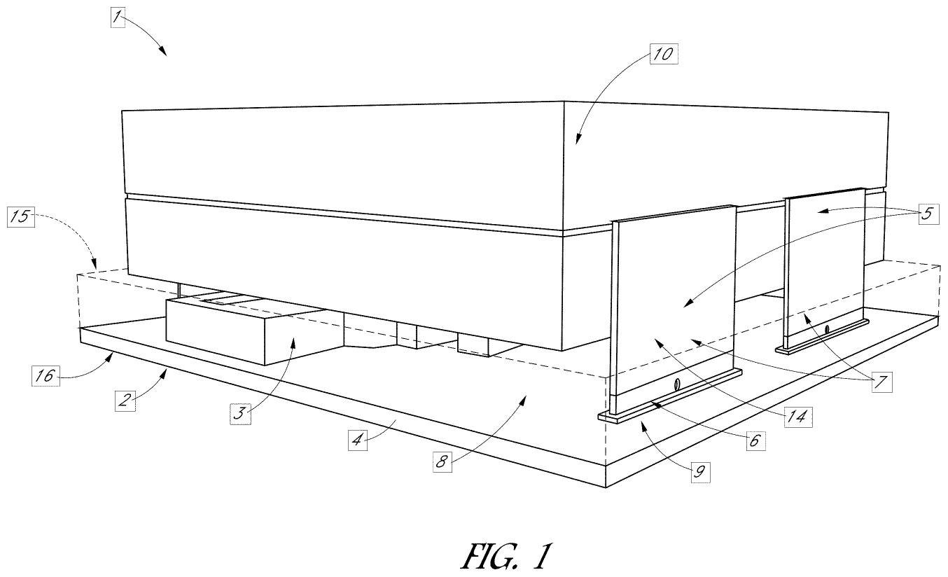

FIGS. 1-3 illustrate examples of electronic assemblies 1, according to various embodiments disclosed herein. The electronic assemblies 1 can be used in any suitable type of electronic system, and can be packaged in any suitable manner. For example, in some embodiments, the electronic assemblies 1 can be used in high power switching systems and can include a component-on-package (CoP) structure in which an electronic device 10 (which can comprise a passive electronic device) can be mounted on an exterior surface 15 of an integrated device package 2. In other embodiments, the electronic assembly 1 may include structures other than CoP structures, and the electronic device 10 can be arranged in any suitable way. For example, in some embodiments, the electronic device 10 may be configured as a standalone device that connect to any suitable package substrate, system board, interposer, or any other suitable carrier. In some embodiments, the electronic device 10 can comprise a passive electronic device, such as an inductor or a transformer. In other embodiments, the electronic device 10 can comprise an active device, such as an integrated device package that includes an integrated device die (e.g., a processing die, memory die, sensor die, microelectromechanical systems die, etc.). The electronic device 10 can be configured to connect to any suitable type of carrier, such as a package substrate, an integrated device die or package, an interposer, etc.

In various embodiments, the passive electronic device 10 can comprise an inductor. In some embodiments, the passive electronic device 10 can comprise a transformer. In still other embodiments, different types of passive electronic devices 10, such as high power resistors, capacitors, or couplers, can be used. The electronic devices 10 described herein can be used in conjunction with any suitable type of electronic assembly, including, e.g., any of the electronic assemblies 1 shown in FIGS. 1-3. For example, the electronic devices 10 can serve as components (e.g., inductors or transformers) to be mounted on the packages shown and described throughout U.S. Patent Publication No. 2020/0152614; U.S. Patent Publication No. 2019/0141834; and U.S. Pat. No. 10,497,635, the entire contents of each of which are hereby incorporated by reference in their entirety and for all purposes.

As shown in FIGS. 1-3, the electronic device 10 (e.g., a passive electronic device), can include a plurality of terminals 5 that electrically connect the electronic device 10 to corresponding leads 9 or pads of the integrated device package 2. As shown, the package 2 can comprise a package substrate 4 having one or a plurality of devices 3 mounted on and electrically connected to the package substrate 4. The devices 3 can comprise any suitable type of device, including a passive electronic device (such as a capacitor, an inductor, etc.), an active electronic device (such as an integrated device die), etc. A molding compound 8 can be provided over the devices 3 and over the substrate 4 in spaces between the devices 3.

In FIG. 1, the terminals 5 of the electronic device 10 comprise through mold slotted vias (TMSVs) 7 disposed along an exterior side surface of the electronic device 10. As shown in FIG. 1, for example, the TSMVs 7 can be disposed along the same side surface, but in other embodiments, the TSMVs 7 can be disposed on different surfaces. In the illustrated embodiment, the TSMVs 7 can connect to respective positive and negative terminals or leads 9 of the passive electronic device 10. In other embodiments, more than two terminals 5 (e.g., TSMVs 7) can be used to connect to additional I/O pins of the electronic device 10. As shown in FIG. 1, the TSMVs 7 can extend downwardly below a bottom surface of the electronic device 10 and can be inserted into corresponding slot(s) 14 formed in the molding compound 8 of the integrated device package 2. The TSMVs 7 can contact the corresponding leads 9 or electrodes of the package (e.g., solder pads 6). Solder can be applied to electrically connect the solder pads 6 to the terminals 5. The package substrate 4 can include traces that can electrically connect the various other devices 3 of the package 2 (such as integrated device dies, other passive electronic devices, etc.) to the passive electronic device 10 mounted to the exterior surface 15. A bottom surface 16 of the substrate 6 can include conductive lands for electrically connecting and/or mounting the electronic assembly 1 to an external device, such as a system motherboard (not shown).

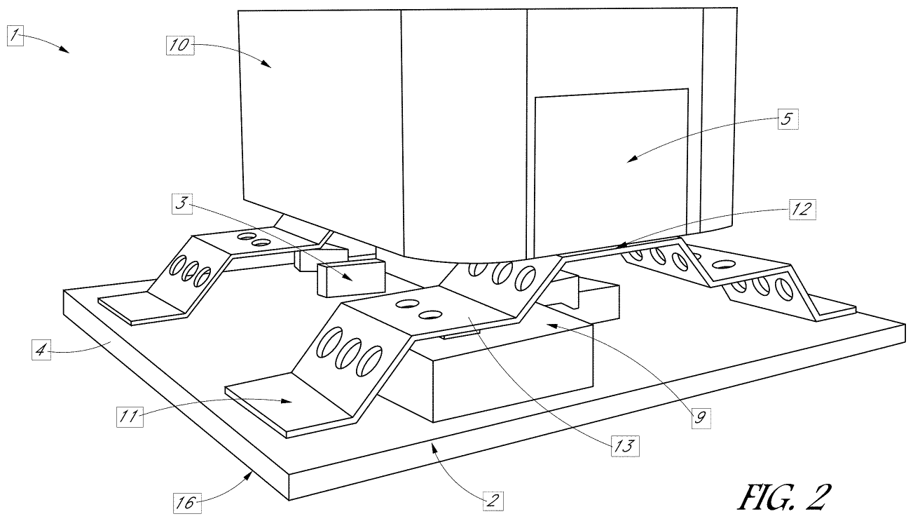

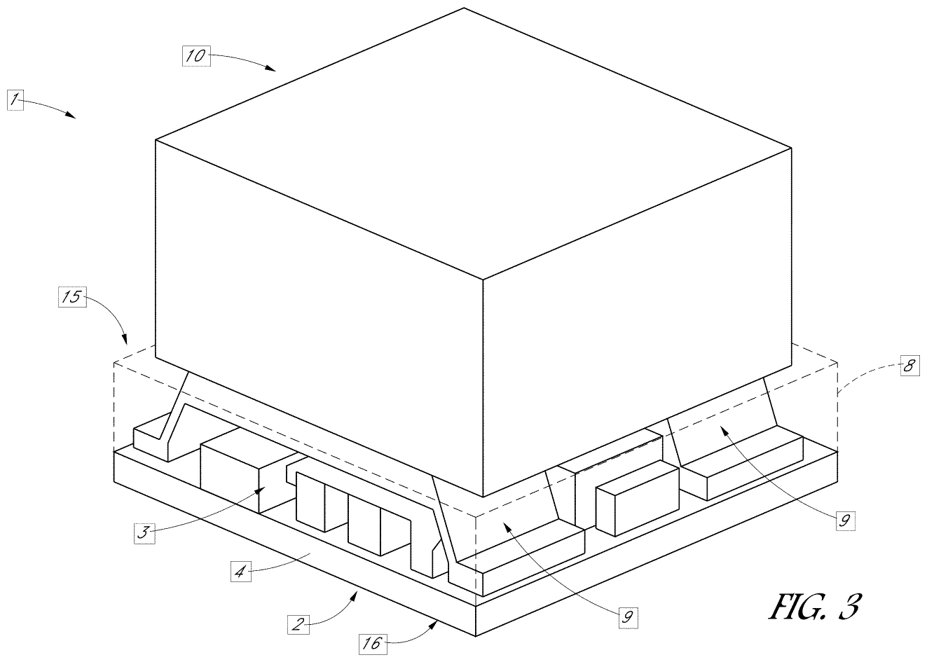

In FIGS. 2 and 3, the terminals 5 can comprise pads or lands on the bottom surface of the passive electronic device 10. As shown in FIG. 2, the package can include leads 9 that comprise a plurality of (e.g., two) leadframes mounted to and spaced apart from one another along the upper surface of the substrate 4. The leads 9 can comprise one or more feet 11 mounted and electrically connected to corresponding pads on the substrate 4, contact pads 12 exposed at the exterior surface 15 of the package 2, and one or more extension portions 13 extending between the foot 11 and the contact pad 12. The extension portions 13 can include steps that extend vertically upward through the molding compound 8 between the feet 11 and the contact pad 12. The terminals 5 of the electronic device 10 (which can extend on bottom and side surfaces of the electronic device 10) can connect to corresponding contact pads 12 of the leads 9 (e.g., quad flat no lead, or QFN, leads) or electrodes of the package 2. For example, as shown in FIGS. 2 and 3, the terminals 5 of the electronic device 10 can be mounted on and electrically connected to the contact pads 12 of the leads 9.

Beneficially, the arrangements of FIGS. 1-3 can utilize vertical space to accommodate the relatively large passive electronic devices 10, which can comprise an inductor in the illustrated embodiments. Mounting the electronic device 10 (e.g., inductor) to the exterior surface 15 of the package 2 can therefore preserve customer board space. The assembly 1 can accommodate larger devices in the vertical direction so that overall system performance and integration is maintained or improved.

Various embodiments disclosed herein can integrate a heat-dissipation mechanism 17 into the passive electronic device 10. For example, various embodiments disclosed herein relate to passive electronic devices 10 comprising an electronic component 30 that include a conductive element 20 comprising an inductor coil 19. The electronic device 10 can further include a shaped body 22 (e.g., a molded body) in which the conductive element 20 is at least partially embedded. The shaped body 22 can be formed so as to increase the surface area of the passive electronic device 10 and improve heat dissipation therefrom. In various embodiments, for example, the shaped body 22 can be molded, stamped, formed, bent, machined, etched, milled, three-dimensionally (3D) printed, etc. In various embodiments, the shaped body 22 can comprise a seamless monolithic structure. For example, in some embodiments, the shaped body 22 can comprise a molded body that can include a plurality of heat-dissipating projections 24 extending outwardly from a base portion 25 of the shaped body 22. The heat-dissipating projections 24 can comprise fins, pins, dimples, or other elongate structures that increase the surface area or topology of the passive electronic device 10 relative to a planar surface. The projections 24 can be spaced apart by gaps 23 comprising a gas, such as air.

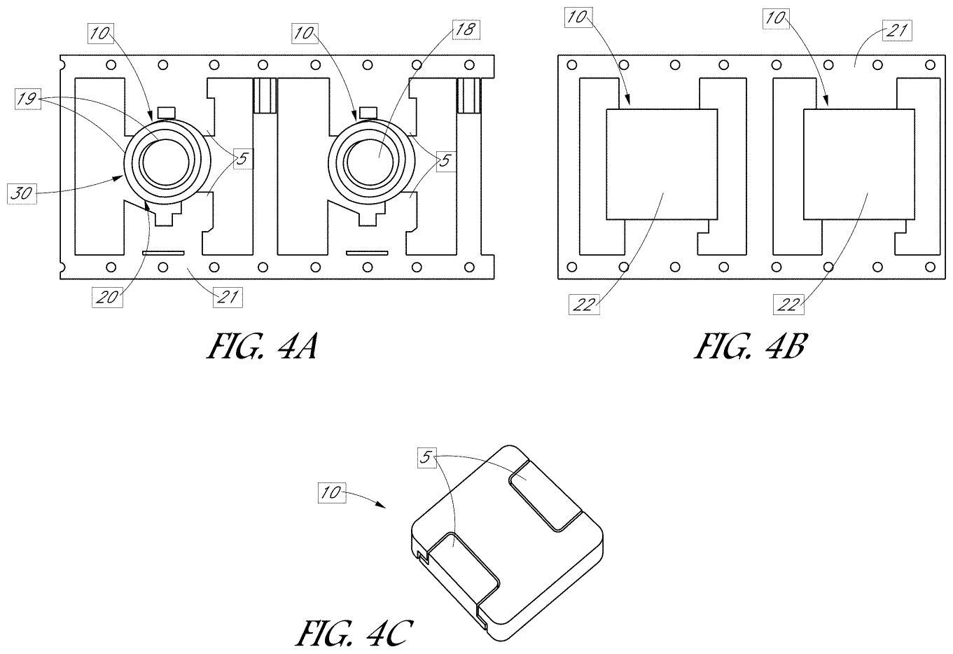

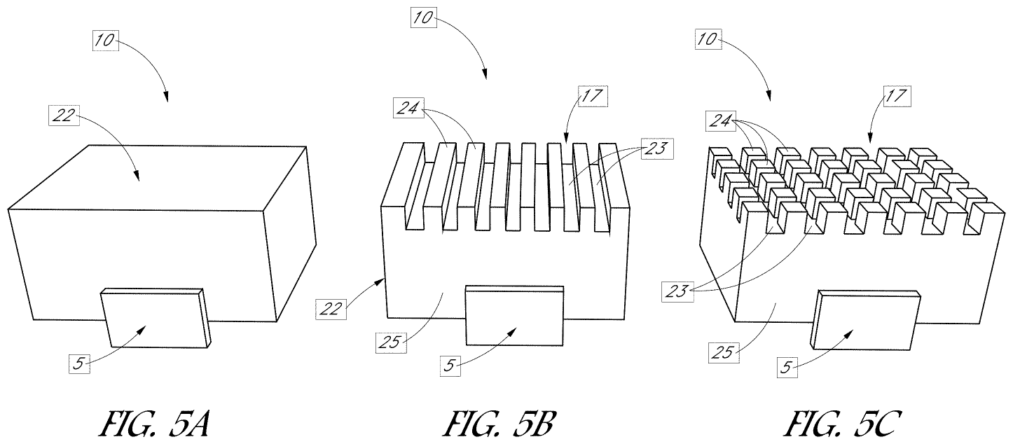

In some embodiments, as shown in FIG. 4A, the conductive element 20 can comprise an inductor coil 19. In some embodiments the conductive element 20 can comprise or be part of a transformer (e.g., at least one transformer coil). In FIG. 4A, the inductor coil 19 can have a plurality of turns and can be supported during manufacture by a frame 21. As shown, the terminals 5 can comprise ends of the coil 19 in various embodiments. The coil 19 can extend around an interior region 18. In other embodiments, the conductive element 20 of the passive electronic device 10 can include a transformer (e.g., one or a plurality of inductor coils). In FIGS. 4B, 4C, and 5A, a shaped body 22 (e.g., a molded body) can be formed in which the inductor coil 19 is at least partially embedded (e.g., completely embedded) in the molded body 22. Upon molding the shaped body 22, the electronic device 10 can be separated from the frame 21 to form the separate electronic devices 10 shown in FIGS. 4C and 5A. In the electronic devices 10 shown in FIGS. 4C and 5A, the molded body 22 can comprise a smooth rectangular prism-shaped device.

For various high power applications, the electronic device 10 shown in FIGS. 4C and 5A may generate a significant amount of heat. For example, in some high power applications, the electronic device 10 can generate power of at least 100 W, at least 500 W, at least 1 kW, or at least 3 kW. In some embodiments, the electronic device 10 can generate power in a range of 100 W to 5 kW, in a range of 500 W to 5 kW, in a range of 1 kW to 5 kW, or in a range of 3 kW to 5 kW. In some applications, the electronic device 10 can operate at one or more frequencies in a range of 30 kHz to 3 MHz, in a range of 100 kHz to 3 MHz, or in a range of 1 MHz to 3 MHz. The electronic device 10 can accommodate high relative currents, including current in a range of 50 A to 1000 A, in a range of 100 A to 1000 A, or in a range of 500 A to 1000 A. As explained herein, in some embodiments, the electronic device 10 can comprise a passive device, such as an inductor or transformer. In embodiments that include an inductor, the inductance can be at least 10 μH, at least 50 μH, or at least 100 μH, for example, in a range of 10 μH to 100 μH.

Accordingly, high power devices like those disclosed herein can generate significant heat. It can be important to effectively remove the generated heat from the electronic device 10. As shown in FIGS. 5B-5C, the shaped body 22 can be shaped (e.g., molded) to include a heat-dissipation mechanism 17 that includes the plurality of projections 24. For example, the shaped body 22 can include a base portion 25 in which the conductive element 24 is at least partially (e.g., completely) embedded. The projections 24 can extend from the base portion 25. The shaped body 22 can comprise a polymer and magnetic filler material that serves as the core of the inductor device (or transformer device) to store magnetic energy.

For example, various embodiments can employ a ferrite molding process to provide thermally enhanced, high power passive electronic devices 10, such as high power inductors and transformers, by modifying the molded ferrite body 22 to increase the surface area so as to dissipate heat from the electronic device 10. In various embodiments, mold tooling can be formed or modified so that the shape of the passive device 10 includes a plurality of heat-dissipating projections 24, e.g., a pin-type (FIG. 5C) or fin-type (FIG. 5B) heat sink. As illustrated herein in FIG. 5B, for example, the projections 24 can comprise a plurality of elongate fins. The fins in FIG. 5B can extend across a width of the passive electronic device 10. The fins in FIG. 5B can be spaced along a length of the passive electronic device 10 in a one-dimensional (1D) array of projections 24. In other embodiments, as shown in FIG. 5C, the projections 24 can comprise a plurality of pins disposed in an array at an upper side of the passive electronic device 10. The pins of FIG. 5C can be disposed in a two-dimensional (2D) array in which pins are spaced apart along the width and length of the passive electronic device 10. In some embodiments, the ferrite material of the shaped body 22 can be post-processed to add the projections 24 (e.g., pins or fins) by sawing or another similar material removal or modification process. Increasing the surface area of the passive electronic device 10 by providing the projections 24 can improve thermal efficiency in devices 10 with convective cooling. As shown, for example, the projections 24 can be spaced apart by the gaps 23, which can comprise a gas such as air, such that heat can be conveyed away from the electronic device 10.

The shaped body 22 can accordingly serve as a core of the electronic device 10 (e.g., a core of an inductor or transformer), in which a polymer or ceramic with magnetic filler particles is disposed in the base portion 25, including within the interior region 18 of the conductive element 20 (e.g., the inductor coil 19). The remainder of the shaped body 22 outside the inductor coil 19 and extending from the base portion 25 can form the plurality of heat-dissipating projections 24. In some embodiments, the remainder of the shaped body outside the inductor coil 19 can serve as a shield for the electronic device 10. In various embodiments, the molding process can cause the material of the molded body 22 to extend within the interior region 18, around the surfaces of the coil 19, and in small spaces between adjacent turns of the coil 19, such that the conductive element 20 is embedded within the molded body 22. The molded body 22 (including the base portion 25 and projections 24) can comprise a seamless monolithic body. The molded body 22 may be devoid of a separate heat sink attached or otherwise connected to the body 22. Rather, as explained herein, the molded body 22 can serve as the inductor core to store magnetic energy and can also be shaped to form the heat-dissipating mechanism 17, such that the heat-dissipating mechanism 17 (e.g., the projections 24) are formed from the same material as, and integrally and seamlessly formed with, the magnetic core of the electronic device 10 (e.g., the inductor or transformer core). In some embodiments, as explained herein, the shaped body 22 can be molded over the electronic component 30 (e.g., the inductor or transformer in the embodiment of FIGS. 5B-5C). In such embodiments, the molding process can cause the base portion 25 to adhere and conform to the structure of the component 30 (e.g., to the structure of the conductive element 20 including the coil 19). Beneficially, the device 10 may not include a separate heat sink structure that is not integrated with the component 30.

Thus, the embodiments disclosed herein can form a heat-dissipation mechanism 17 comprising a heat sink by creating a finned or pinned projections 24 that comprise a ferrite material (e.g. , a shaped or molded body 22) integrated with a passive electronic device 10, such as an inductor, a transformer, a resistor, etc., to increase the surface area to further improve the efficient removal of heat. The ferrite cores used in the material of the shaped body 22 can comprise dense, homogeneous ceramic structures which can be made by mixing iron oxide (Fe₂O₃) with oxides or carbonates of one or more metals such as manganese, zinc, nickel, or magnesium. The ferrite material can be pressed or molded, fired (for example, up to approximately 1300° C.), and machined as desired to form the shaped body 22 and to meet various mechanical and electrical parametric goals. Powdered iron or composite power inductor construction can utilize a pre-wound coil 19 of wire that is connected to (e.g., welded into) a lead frame, e.g., the frame 22. The assembly (e.g., the coil 19) can be placed in a die (e.g., a steel die) that is filled with powdered metal, insuring that the powder completely surrounds the coil 19, including, e.g., within the interior region 18, around exterior surfaces of the coil 19, and within spaces between portions of the wire in the coil 19. The powdered metal can then be compressed by tooling from above and below to form a dense shielded magnetic body 22 around and within the coil 19. The dense shielded magnetic body 22 around the coil 19 serves as an excellent heat spreader for the material typology used and can be used as a heat sink, or a heat sink interface, to draw the heat from the integrated device package 2 into the coil windings, into the shaped body 22 (e.g., molded powdered iron or composite material), and away from the integrated device package 2.

Other devices typically utilize heat sinks as a separate component, which increases material and processing costs, and may not be as efficient due to high thermally resistant polymers and adhesives used to attach the separate heat sink to the device to be cooled. In the embodiments disclosed herein, the shaped passive electronic device 10 with heat-dissipating projections 24 can be integrated into an inductor/ferrite manufacturing process with little to no impact to pricing. Further, as explained above, increasing the available surface area for improved convective thermal dissipative properties can provide the ability to operate the finished module at high dissipative power densities.

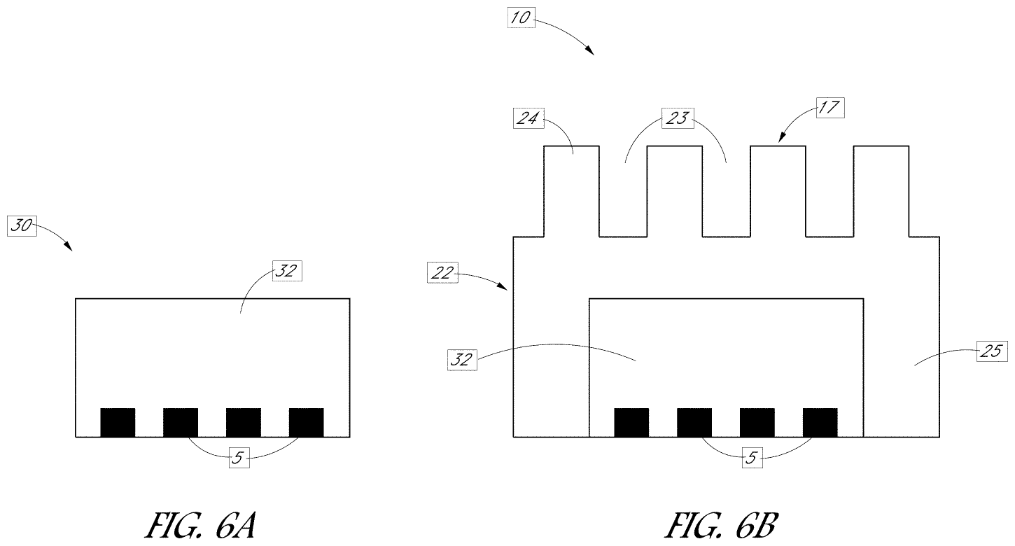

FIGS. 6A-6B illustrate another example of an electronic device 10 that includes a shaped body 22 that may be generally similar in function to the shaped body 22 described in connection with FIGS. 5B-5C. As explained herein, the electronic device 10 can include any suitable type of electronic component 30. In the embodiment of FIGS. 6A-6B, the electronic component 30 can comprise an integrated device die 32 having active devices or circuitry integrated therewith or coupled thereto. The integrated device die 32 can comprise a semiconductor die, such as a processor die, a memory die, a sensor die, a microelectromechanical systems die, etc. The die 32 can include terminals 5 configured to connect to any suitable carrier. In the illustrated embodiment, the terminals 5 can be disposed on the bottom surface of the die 32. As shown in FIG. 6B, the shaped body 22 can be provided (e.g., molded) over and around the die 32 such that the die 32 is at least partially embedded in the shaped body 22. For example, the shaped body 22 can extend along upper and side surfaces of the die 32. In some embodiments, as shown in FIG. 6B, a lower surface of the die 32 that includes the terminals 5 can be exposed through the shaped body 22 such that the terminals 5 can electrically connect to a carrier.

As explained herein, the molded body 22 can be shaped to define the heat-dissipation mechanism 17. Unless otherwise noted, the heat-dissipation mechanism 17 can be generally similar to the heat-dissipation mechanism 17 described above. For example, the heat-dissipation mechanism 17 can include a plurality of projections 24 (e.g., fins or pins) spaced apart by a gap 23 on a side of the device 10 opposite to the terminals 5. The molded body 22 can comprise any suitable thermally-conductive material selected to dissipate heat away from the die 32 towards the projections 24 and the outside environs.

Although disclosed in the context of certain embodiments and examples, it will be understood by those skilled in the art that the present invention extends beyond the specifically disclosed embodiments to other alternative embodiments and/or uses and obvious modifications and equivalents thereof. Further, unless otherwise noted, the components of an illustration may be the same as or generally similar to like-numbered components of one or more different illustrations. In addition, while several variations have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the present disclosure. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the aspects that follow.

What is claimed is:

1. An electronic device comprising:
an electronic component; and
a shaped body in which the electronic component is at least partially embedded, the shaped body comprising a base portion and a plurality of heat-dissipating projections extending outwardly therefrom.

2. The passive electronic device of claim 1, wherein the electronic component comprises a passive electronic device including a conductive element, the conductive element comprising an inductor coil or a transformer coil.

3. The passive electronic device of claim 1, wherein the electronic component comprises an integrated device die.

4. The passive electronic device of claim 1, wherein the projections comprise pins spaced apart in a two-dimensional (2D) array along a width and a length of the electronic device.

5. The passive electronic device of claim 1, wherein the projections comprise fins spaced apart along one dimension of the electronic device.

6. The passive electronic device of claim 1, wherein the shaped body comprises a polymer and magnetic filler material.

7. The passive electronic device of claim 1, further comprising one or more terminals on an exterior surface of the shaped body, the one or more terminals configured to electrically connect to an external device.

8. The passive electronic device of claim 7, wherein the one or more terminals comprises a terminal on a side exterior surface of the shaped body, the terminal extending below a bottom surface of the passive electronic device, the bottom surface opposite a top surface defined at least in part by the plurality of heat-dissipating projections.

9. An electronic device comprising:
an integrated device package comprising one or more integrated device dies; and
a surface-mounted electronic component mounted to an exterior surface of the integrated device package, the surface-mounted electronic component comprising a shaped electronic device, the shaped electronic device having a plurality of integral heat-dissipating projections extending outwardly therefrom.

10. The electronic device of claim 9, wherein the shaped electronic device comprises a passive electronic device and a shaped body in which the passive electronic device is at least partially embedded, the passive electronic device including a conductive element, the conductive element comprising an inductor coil or a transformer coil.

11. The electronic device of claim 10, wherein the shaped body comprises a polymer and magnetic filler material.

12. The electronic device of claim 9, wherein the shaped electronic device comprises an integrated device die.

13. The electronic device of claim 9, wherein the plurality of integral heat-dissipating projections comprise fins spaced apart along one dimension of the electronic device.

14. The electronic device of claim 9, wherein the plurality of integral heat-dissipating projections comprise pins spaced apart in a two-dimensional (2D) array along a width and a length of the electronic device.

15. The electronic device of claim 9, wherein the surface-mounted electronic component comprises one or more terminals electrically connected to corresponding lead(s) of the integrated device package.

16. The electronic device of claim 15, wherein the one or more terminals are inserted into corresponding slot(s) of the integrated device package.

17. A method of manufacturing an electronic device, the method comprising:
at least partially embedding at least one electronic component within a shaped body, the shaped body comprising a plurality of heat-dissipating projections extending outwardly therefrom.

18. The method of claim 17, wherein the electronic component comprises a passive electronic device, the passive electronic device including at least one conductive element, the at least one conductive element comprising an inductor coil or a transformer coil.

19. The method of claim 18, wherein the at least partially embedding comprises molding the at least one conductive element and the plurality of heat-dissipating projections.

20. The method of claim 18, further comprising mounting the passive electronic device to an exterior surface of an integrated device package.
